(19) United States
(12) Patent Application Publication
(10) Pub. No.: US 2021/0390967 A1
(43) Pub. Date: Dec. 16, 2021

(54) METHOD AND APPARATUS FOR ENCODING AND DECODING AUDIO SIGNAL USING LINEAR PREDICTIVE CODING

(71) Applicant: Electronics and Telecommunications Research Institute, Daejeon (KR)

(72) Inventors: Seung Kwon Beack, Daejeon (KR); Jongmo SUNG, Daejeon (KR); Mi Suk LEE, Daejeon (KR); Tae Jin LEE, Daejeon (KR); Woo-taek LIM, Daejeon (KR); Inseon JANG, Daejeon (KR); Jin Soo CHOI, Daejeon (KR)

(73) Assignee: Electronics and Telecommunications Research Institute, Daejeon (KR)

(21) Appl. No.: 17/242,828

(22) Filed: Apr. 28, 2021

(30) Foreign Application Priority Data
Apr. 29, 2020 (KR) 10-2020-0052284

(51) Int. Cl. G10L 19/032; G10L 19/08

(52) U.S. Cl. CPC G10L 19/032; G10L 19/08

(57) ABSTRACT

Disclosed is a method of encoding and decoding an audio signal using linear predictive coding (LPC) and an encoder and a decoder that perform the method. The method of encoding an audio signal to be performed by the encoder includes identifying a time-domain audio signal block-wise, quantizing a linear prediction coefficient obtained from a block of the audio signal through the LPC, generating an envelope based on the quantized linear prediction coefficient, extracting a residual signal based on the envelope and a result of converting the block into a frequency domain, grouping the residual signal by each sub-band and determining a scale factor for quantizing the grouped residual signal, quantizing the residual signal using the scale factor, and converting the quantized residual signal and the quantized linear prediction coefficient into a bitstream and transmitting the bitstream to a decoder.

### CLAIM OF PRIORITY

This application claims the benefit of Korean Patent Application No. 10-2020-0052284 filed on Apr. 29, 2020, in the Korean Intellectual Property Office.

### TECHNICAL FIELD

One or more example embodiments relate to a method of encoding and decoding an audio signal using linear predictive coding (LPC) and an encoder and a decoder that perform the method, and more particularly, to a technology for encoding and decoding an audio signal by estimating a scale factor to quantize a residual signal obtained using LPC.

### BACKGROUND ART

Unified speech and audio coding (USAC) is a fourth-generation audio coding technology that is developed to improve the quality of a low-bit-rate sound that has not been covered before by the Moving Picture Experts Group (MPEG). USAC is currently being used as the latest audio coding technology that provides a high-quality sound for speech and music.

To encode an audio signal through USAC or other audio coding technologies, a linear predictive coding (LPC)-based quantization process may be employed. LPC refers to a technology for encoding an audio signal by encoding a residual signal corresponding to a difference between a current sample and a previous sample among audio samples that constitute the audio signal.

However, the performance of quantizing an audio signal may be limited. Thus, there is a desire for a technology for improving the limited performance.

### DISCLOSURE

### Technical Goals

An aspect provides a method and apparatus for improving the efficiency of quantizing a residual signal that is obtained through linear predictive coding (LPC) to encode and decode an audio signal.

### Technical Solutions

According to an example embodiment, there is provided a method of encoding an audio signal to be performed by an encoder, the method including identifying a time-domain audio signal block-wise, quantizing a linear prediction coefficient obtained from a block of the audio signal through linear predictive coding (LPC), generating an envelope based on the quantized linear prediction coefficient, extracting a residual signal based on the envelope and a result of converting the block into a frequency domain, grouping the residual signal by each sub-band and determining a scale factor for quantizing the grouped residual signal, quantizing the residual signal using the scale factor, and converting the quantized residual signal and the quantized linear prediction coefficient into a bitstream and transmitting the bitstream to a decoder.

The linear prediction coefficient may be generated by performing the LPC on a current block that is used for the LPC among identified blocks, based on information associated with a previous block of the current block and information associated with a subsequent block of the current block.

The generating of the envelope may include converting the quantized linear prediction coefficient into the frequency domain, grouping the converted linear prediction coefficient by each sub-band, and generating the envelope corresponding to the block by calculating energy of the grouped linear prediction coefficient.

The determining of the scale factor may include determining the scale factor by a median value of the envelope, or determining the scale factor based on the number of bits available for quantizing the residual signal.

The number of bits available for the quantizing may be determined for each sub-band. A greater number of bits may be allocated when the sub-band is a lower band, and a smaller number of bits may be allocated when the sub-band is a higher band.

According to another example embodiment, there is provided a method of decoding an audio signal to be performed by a decoder, the method including extracting a quantized linear prediction coefficient and a quantized residual signal from a bitstream received from an encoder, dequantizing the quantized linear prediction coefficient and the quantized residual signal, generating an envelope from the dequantized linear prediction coefficient, extracting a frequency-domain audio signal using the dequantized residual signal and the envelope, and decoding the audio signal by converting the extracted audio signal into a time domain.

The dequantizing of the quantized residual signal may include dequantizing the residual signal using a scale factor determined for each sub-band.

The scale factor may be determined by a median value of the envelope or determined based on the number of bits available for quantizing the residual signal.

The generating of the envelope may include converting the dequantized linear prediction coefficient into a frequency domain, grouping the converted linear prediction coefficient by each sub-band, and generating the envelope by calculating energy of the grouped linear prediction coefficient.

According to still another example embodiment, there is provided an encoder configured to perform a method of encoding an audio signal, the encoder including a processor. The processor may identify a time-domain audio signal block-wise, quantize a linear prediction coefficient obtained from a block through LPC, generate an envelope based on the quantized linear prediction coefficient, extract a residual signal based on the envelope and a result of converting a block of the audio signal into a frequency domain, group the residual signal by each sub-band, determine a scale factor for quantizing the grouped residual signal, quantize the residual signal using the scale factor, and convert the quantized residual signal and the quantized linear prediction coefficient into a bitstream and transmit the bitstream to a decoder.

The linear prediction coefficient may be generated by performing the LPC on a current block that is used for the LPC among identified blocks, based on information associated with a previous block of the current block and information associated with a subsequent block of the current block.

The processor may convert the quantized linear prediction coefficient into the frequency domain, group the converted linear prediction coefficient by each sub-band, and generate the envelope corresponding to the block by calculating energy of the grouped linear prediction coefficient.

The processor may determine the scale factor by a median value of the envelope or determine the scale factor based on the number of bits available for quantizing the residual signal.

The number of bits available for the quantizing may be determined for each sub-band. A greater number of bits may be allocated when the sub-band is a lower band, and a smaller number of bits may be allocated when the sub-band is a higher band.

According to yet another example embodiment, there is provided a decoder configured to perform a method of decoding an audio signal, the decoder including a processor. The processor may extract a quantized linear prediction coefficient and a quantized residual signal from a bitstream received from an encoder, dequantize the quantized linear prediction coefficient and the quantized residual signal, generate an envelope from the dequantized linear prediction coefficient, extract a frequency-domain audio signal using the dequantized residual signal and the envelope, and decode the audio signal by converting the extracted audio signal into a time domain.

The processor may dequantize the residual signal using a scale factor determined for each sub-band.

The scale factor may be determined by a median value of the envelope or determined based on the number of bits available for quantizing the residual signal.

The generating of the envelope may include converting the dequantized linear prediction coefficient into a frequency domain, grouping the converted linear prediction coefficient by each sub-band, and generating the envelope by calculating energy of the grouped linear prediction coefficient.

According to further example embodiment, there is provided a method of encoding an audio signal to be performed by an encoder, the method including obtaining a residual signal from an audio signal through LPC, allocating the number of bits to be used for quantizing the residual signal for each sub-band, determining a scale factor by comparing the number of bits used for the quantizing and energy of the residual signal for each sub-band, and converting the residual signal quantized using the scale factor into a bitstream.

According to further example embodiment, there is provided a method of decoding an audio signal to be performed by a decoder, the method including extracting a quantized residual signal and a quantized linear prediction coefficient from a bitstream received from an encoder, dequantizing the quantized residual signal, obtaining a frequency-domain audio signal using an envelope that is generated from the dequantized residual signal and the quantized linear prediction coefficient, and performing decoding by converting the frequency-domain audio signal into a time-domain audio signal.

### Advantageous Effects

According to example embodiments described herein, it is possible to increase the efficiency of quantizing a residual signal obtained through linear predictive coding (LPC) in a process of encoding and decoding an audio signal.

### BRIEF DESCRIPTION OF DRAWINGS

FIG. 1 is a diagram illustrating an example of an encoder and an example of a decoder according to an example embodiment.

FIG. 2 is a diagram illustrating an example of an operation of an encoder and an example of an operation of a decoder according to an example embodiment.

FIG. 3 is a flowchart illustrating an example of a method of generating an envelope according to an example embodiment.

FIG. 4 is a flowchart illustrating an example of a method of quantizing a residual signal according to an example embodiment.

FIG. 5 is a diagram illustrating examples of a graph of experimental results according to an example embodiment.

### BEST MODE FOR CARRYING OUT THE INVENTION

Hereinafter, example embodiments will be described in detail with reference to the accompanying drawings. However, various alterations and modifications may be made to the examples. Here, the examples are not construed as limited to the disclosure and should be understood to include all changes, equivalents, and replacements within the idea and the technical scope of the disclosure.

The terminology used herein is for the purpose of describing only particular examples and is not to be limiting of the examples. As used herein, the singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains consistent with and after an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Also, in the description of example embodiments, detailed description of structures or functions that are thereby known after an understanding of the disclosure of the present application will be omitted when it is deemed that such description will cause ambiguous interpretation of the example embodiments. Hereinafter, example embodiments will be described in detail with reference to the accompanying drawings, and like reference numerals in the drawings refer to like elements throughout.

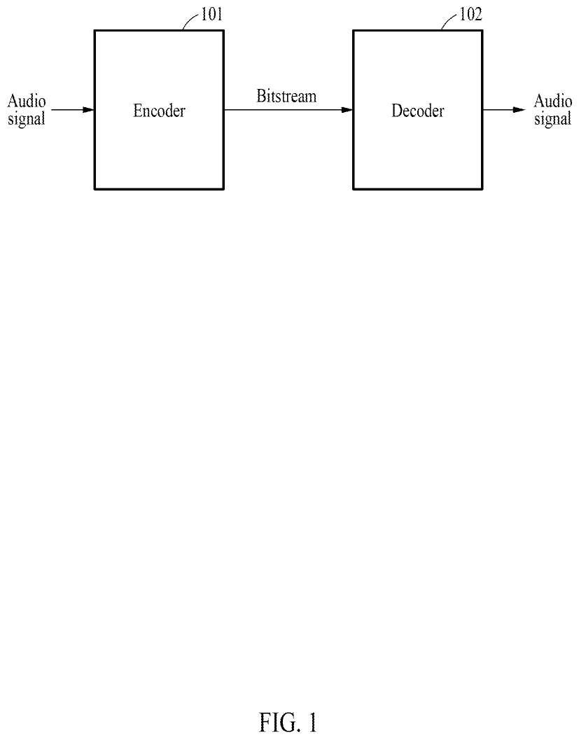

FIG. 1 is a diagram illustrating an example of an encoder and an example of a decoder according to an example embodiment.

An audio signal may be encoded by quantizing a residual signal that is obtained from the audio signal through linear predictive coding (LPC).

Example embodiments described herein relate to an encoding and decoding technology that estimates a multi-band quantization scale factor in a process of quantizing a residual signal and effectively quantizes the residual signal based on the estimated scale factor.

An encoder 101 and a decoder 102 may be processors performing, respectively, an encoding method and a decoding method that are described herein. The encoder 101 and the decoder 102 may be the same processor or different processors.

Referring to FIG. 1, the encoder 101 may convert an audio signal into a bitstream by processing the audio signal, and transmit the bitstream to the decoder 102. The decoder 102 may reconstruct an audio signal using the received bitstream.

For example, the encoder 101 and the decoder 102 may process an audio signal block-wise. The audio signal may include time-domain audio samples, and a block of the audio signal, or an audio signal block herein or simply a block, may include a plurality of audio samples indicating a predetermined time interval.

The encoder 101 may generate a linear prediction coefficient from an audio signal block through LPC. The encoder 101 may then quantize the generated linear prediction coefficient and generate an envelope using the quantized linear prediction coefficient.

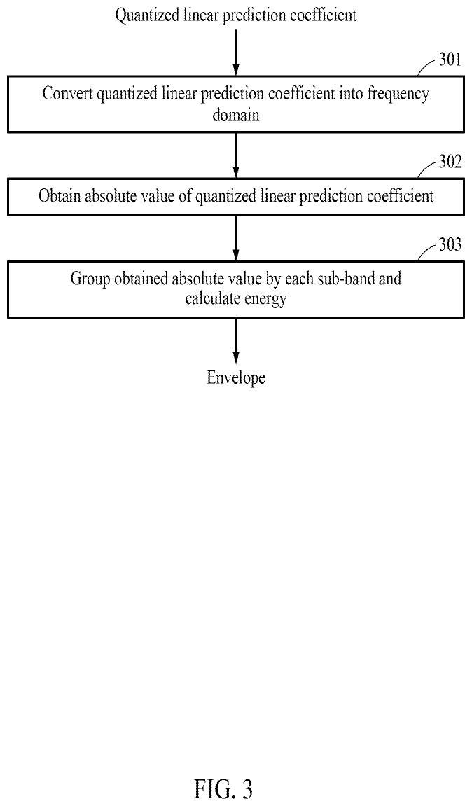

The envelope described herein may indicate a curve in a shape that envelops a waveform of a residual signal, and thus indicate a rough outer shape of the residual signal. The envelope of the audio signal may be generated through the quantized linear prediction coefficient. A detailed method of calculating an envelope will be described hereinafter with reference to FIG. 3.

The encoder 101 may extract a residual signal using the envelope and a result of converting the audio signal block into a frequency domain. The encoder 101 may use a determined scale factor to quantize the extracted residual signal. The encoder 101 may then convert the quantized residual signal and the quantized linear prediction coefficient into a bitstream and transmit the bitstream to the decoder 102.

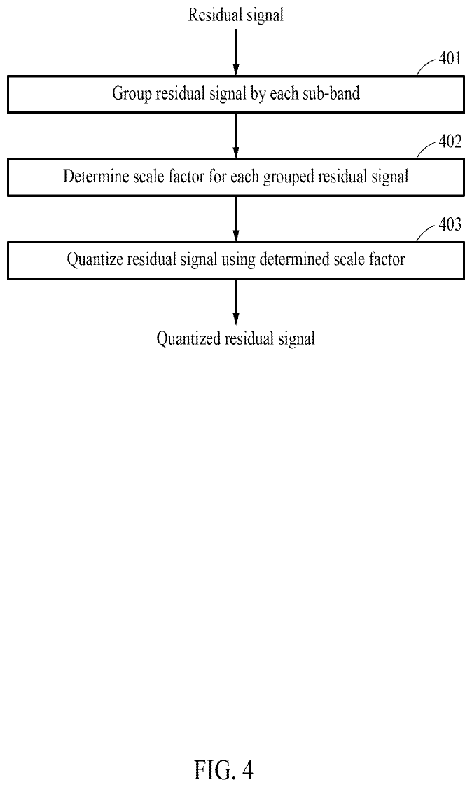

According to an example embodiment, the encoder 101 may use a multi-band scale factor to increase the efficiency of quantizing a residual signal. The scale factor may be determined for each sub-band, and be used to reduce a frequency component of the residual signal based on the number of bits that are used for quantization in a process of quantizing the residual signal. A detailed method of determining a scale factor will be described hereinafter with reference to FIG. 4.

The decoder 102 may obtain the quantized linear prediction coefficient and the quantized residual signal from the received bitstream. The decoder 102 may dequantize the quantized linear prediction coefficient and the quantized residual signal.

The decoder 102 may then generate a frequency-domain audio signal using the dequantized residual signal and an envelope generated using the dequantized linear prediction coefficient. The decoder 102 may reconstruct the audio signal input to the encoder 101 by converting the generated audio signal into a time-domain audio signal.

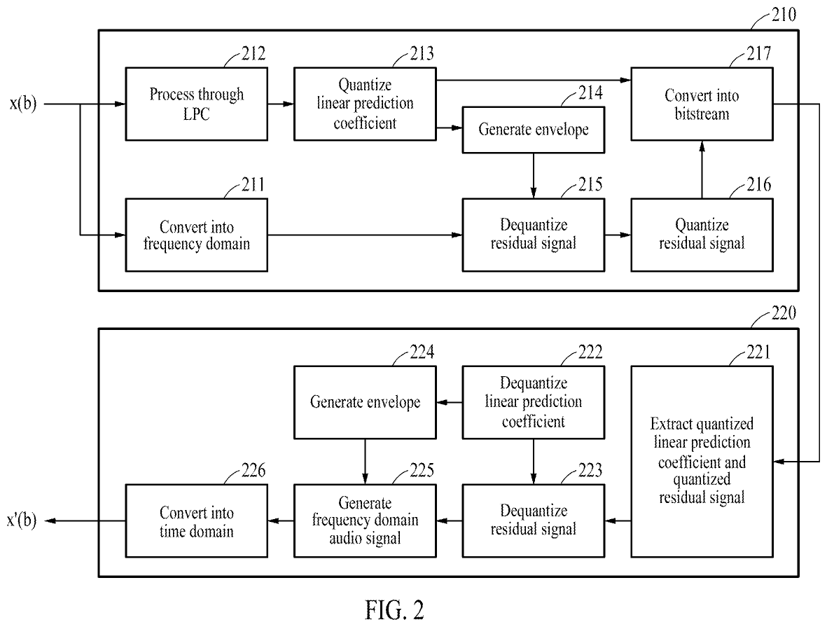

Detailed operations of the encoder 101 and the decoder 102 will be described hereinafter with reference to FIG. 2.

FIG. 2 is a diagram illustrating an example of an operation of an encoder and an example of an operation of a decoder according to an example embodiment.

Referring to FIG. 2, an encoder 210 may receive a block x(b) that constitutes an audio signal and perform encoding thereon. In operation 211, the encoder 210 may convert a block of a time-domain audio signal into a frequency domain. For example, to convert the block into the frequency domain, the encoder 210 may use a modified discrete cosine transform (MDCT) or a discrete Fourier transform (DFT).

In operation 212, the encoder 210 may obtain a linear prediction coefficient from the block through LPC. The linear prediction coefficient may be obtained by dividing an input sound into frames and minimizing energy of a prediction error for each frame.

To stably provide information associated with the block, the encoder 210 may perform LPC on a current block, for example, the block x(b), that is used for LPC among blocks of the audio signal, based on information associated with a previous block x(b−1) and information associated with a subsequent block x(b+1).

Operations 211 and 212 may be performed in parallel in the encoder 210.

In operation 213, the encoder 210 may quantize the linear prediction coefficient. For example, the encoder 210 may transform the linear prediction coefficient into a form advantageous to quantization, for example, an immittance spectral frequency (ISF) or line spectral frequency (LSF) coefficient, and then quantize the linear prediction coefficient through various quantization methods, for example, a method using a vector quantizer. However, a method of quantizing the linear prediction coefficient is not limited to the foregoing examples, and other methods that are used in an audio codec, such as, for example, unified speech and audio coding (USAC) or adaptive multi-rate (AMR) audio codec, may also be used.

In operation 214, the encoder 2101 may generate an envelope using the quantized linear prediction coefficient. The encoder 210 may convert the quantized linear prediction coefficient into the frequency domain. For example, the encoder 210 may convert the linear prediction coefficient into the frequency domain using a DFT. However, a method of converting into the frequency domain is not limited to the foregoing example, and other methods may also be used.

The converted linear prediction coefficient may be indicated as a complex number. The encoder 210 may obtain an absolute value of the converted linear prediction coefficient. The encoder 210 may then group the absolute value of the linear prediction coefficient by each sub-band. The encoder 210 may generate an envelope corresponding to the block by calculating energy of the absolute value grouped for each sub-band.

In operation 215, the encoder 210 may obtain a residual signal of the block by processing the envelope and the block converted into the frequency domain. An additional description of how the envelope is generated and how the residual signal is obtained will be provided hereinafter with reference to FIG. 3.

In operation 216, the encoder 210 may quantize the residual signal. For example, the encoder 210 may group the residual signal by each sub-band, and determine a scale factor for each grouped residual signal. The encoder 210 may quantize the residual signal using the determined scale factor.

For example, the encoder 210 may subtract, from the residual signal, the scale factor determined for each sub-band based on the number of bits that are available for quantization in a process of quantizing the residual signal, thereby increasing a quantization efficiency. An additional description of quantizing a residual signal will be provided hereinafter with reference to FIG. 3.

In operation 217, the encoder 210 may convert the quantized residual signal and the quantized linear prediction coefficient into a bitstream, and transmit the bitstream to a decoder 220 such that the decoder 220 may reconstruct an audio signal through LPC.

To convert the quantized residual signal and the quantized linear prediction coefficient into the bitstream, the encoder 210 may perform lossless coding based on entropy coding.

Referring again to FIG. 2, the decoder 220 may receive, from the encoder 210, the bitstream generated by the encoder 210.

In operation 221, the decoder 220 may extract the quantized linear prediction coefficient and the quantized residual signal by converting the bitstream received from the encoder 210. In operations 222 and 223, the decoder 220 may dequantize the quantized linear prediction coefficient and the quantized residual signal. The dequantizing or dequantization described herein may be construed as being a process of inversely performing quantization.

In operation 224, the decoder 220 may generate an envelope using the dequantized linear prediction coefficient. The generating of the envelope is the same process as performed in the encoder 210. For example, the decoder 220 may convert the dequantized linear prediction coefficient into the frequency domain. In this example, the decoder 220 may convert the linear prediction coefficient into the frequency domain using a DFT, for example. However, a method of converting into the frequency domain is not limited to the foregoing example, and other methods may also be used.

The converted linear prediction coefficient may be indicated as a complex number. The decoder 220 may obtain an absolute value of the converted linear prediction coefficient. The decoder 220 may then group the absolute value of the linear prediction coefficient by each sub-band. The decoder 220 may generate the envelope corresponding to an audio signal block by calculating energy of the absolute value of the linear prediction coefficient grouped for each sub-band.

In operation 225, the decoder 220 may generate a block of a frequency-domain audio signal using the envelope and the dequantized residual signal. In operation 226, the decoder 220 may decode the audio signal by converting the audio signal into a time domain. In FIG. 2, x′(b) indicates an audio signal block reconstructed from x(b).

The decoder 220 may reconstruct an audio signal by sequentially combining blocks of the audio signal.

FIG. 3 is a flowchart illustrating an example of a method of generating an envelope according to an example embodiment.

An encoder may generate an envelope based on a quantized linear prediction coefficient. In operation 301, the encoder may convert the quantized linear prediction coefficient into a frequency domain. For example, the encoder may convert the linear prediction coefficient into the frequency domain using a DFT. However, a method of converting into the frequency domain is not limited to the foregoing example, and other methods may also be used.

The converted linear prediction coefficient may be indicated as a complex number. In operation 302, the encoder may calculate an absolute value of the converted linear prediction coefficient for each frequency resolution. In operation 303, the encoder may group absolute values of the linear prediction coefficient by each sub-band, and calculate energy of the absolute values grouped by each sub-band, thereby generating an envelope corresponding to a block of an audio signal.

The encoder may generate the envelope by calculating the energy of the grouped linear prediction coefficient as represented by Equation 1 below.

$$env ( k ) = \frac{1}{\begin{matrix}A ( k + 1 ) - \\ A ( k ) + 1\end{matrix}} \times 10 \times log 10 [ {\sum }_{k = A ( k )}^{k = A ( k + 1 )} abs {( {lpc}_{f ( k )} )}^{2} ] \\ 0 \leq k \leq K - 1 \qquad [ Equation 1 ]$$

In Equation 1 above, K denotes the number of sub-bands, and k denotes one of the sub-bands. A( ) denotes an index corresponding to a boundary between the sub-bands. Thus, A(k+1)−A(k) denotes a range of a kth sub-band. env(k) denotes a value of an envelope in the kth sub-band. abs( ) denotes a function that outputs an absolute value of an input value. 1pc_{f(k)} denotes a linear prediction coefficient converted into the frequency domain.

That is, the encoder may divide, by a range of the sub-band, a sum of the absolute values of the linear prediction coefficient of the frequency domain for each sub-band, and calculate average energy of the linear prediction coefficient for each sub-band. The encoder may then generate the envelope based on the energy calculated for each sub-band.

The encoder may extract a residual signal using the envelope and a result of converting the block into the frequency domain. For example, the encoder may calculate a residual signal for each sub-band. The encoder may extract the residual signal as represented by Equations 2 and 3 below.

abs(res(A(k):A(k+1)))=10 log 10(abs(x_{f}[A(k):A(k+1)])²)−env(k), 0≤k≤K−1 [Equation 2]

angle(res(A(k):A(k+1)))=angle(x_{f}[A(k):A(k+1)]), 0≤k≤K−1 [Equation 3]

In Equation 2 above, A(k):A(k+1) denotes an interval corresponding to a kth sub-band. The encoder may determine an absolute value of an audio signal (x_{f}[A(k):A(k+1)]) corresponding to the kth sub-band in a block of the audio signal converted into the frequency domain, calculate a difference from an envelope (env(k)) corresponding to the kth sub-band, and obtain an absolute value of a residual signal (res(A(k):A(k+1))) corresponding to the kth sub-band.

In Equation 3 above, angle( ) denotes an angle function, which is a function that returns a phase angle of an input value. That is, the encoder may calculate a phase angle of the residual signal (res(A(k):A(k+1))) corresponding to the kth sub-band based on a phase angle of the audio signal (x_{f}[A(k):A(k+1)]) corresponding to the kth sub-band.

The encoder may obtain the residual signal from the phase angle and the absolute value of the residual signal, as represented by Equation 4 below.

res(A(k):A(k+1))=abs(res(A(k):A(k+1)))exp(j×angle(res(A(k):A(k+1))) [Equation 4]

In detail, the encoder may determine the residual signal by multiplying an output value of an exponential function (exp( )) associated with the phase angle of the residual signal corresponding to the kth sub-band and the absolute value of the residual signal corresponding to the kth sub-band. In Equation 4 above, j denotes a variable indicating a complex number. The encoder may generate the residual signal (res(b)) corresponding to the block based on Equations 1 through 4 above. Audio signal blocks converted into the frequency domain may be symmetrical, and thus a residual signal for half the blocks may only be quantized.

For example, when an audio signal block includes N samples and M=N/2, the audio signal block may be represented by Equation 5 below, and a residual signal corresponding to the audio signal block and used for quantization may be defined as represented by Equation 6 below.

x(b)=[x(b−N+1),x(b−N+2), . . . ,x(b)]^{T} [Equation 5]

res(b)=[res(b−M+1), . . . ,res(b)] [Equation 6]

In Equations 5 and 6 above, b denotes an index of a block, and each of x(b−N+1) and x(b−N+2) corresponds to one sample.

FIG. 4 is a flowchart illustrating an example of a method of quantizing a residual signal according to an example embodiment.

In operation 401, an encoder may group a residual signal by each sub-band. The grouping by each sub-band may be performed separately from operation 303 described above with reference to FIG. 3. The grouping in operation 401 may be performed to vary the number of bits used for quantization for each sub-band. Here, a greater number of bits may be allocated when a sub-band is a low band. In contrast, a smaller number of bits may be allocated when a sub-band is a high band. The number of bits used for quantization may indicate a resolution of quantization.

A residual signal corresponding to a kth sub-band may be defined based on Equation 7 below.

res(k)=[res(B(k−1),res(B(k−1)+1),res(B(k+1)−1)]^{T}, 0≤k≤B−1 [Equation 7]

In Equation 7 above, B denotes the number of sub-bands, which is the same as M in Equation 6. k denotes one of the sub-bands. B( ) denotes an index corresponding to a boundary between the sub-bands, and B(0) may be 0. Thus, in a process for sub-band quantization, res(k) denotes a residual signal corresponding to a sub-band interval from B(k−1) to B(k+1).

In operation 402, the encoder may determine a scale factor for quantization of each grouped residual signal. That is, the encoder may estimate the scale factor for each sub-band. For example, the encoder may determine the scale factor by a median value of a residual signal and determine the scale factor based on the number of bits available for quantizing a residual signal.

When the scale factor is determined based on the number of bits available for quantizing the residual signal, the encoder may allocate the number of bits available for quantization for each sub-band. For the number of bits to be used for quantization, a greater number of bits may be allocated when a sub-band is a lower band, and a smaller number of bits may be allocated when a sub-band is a higher band.

The encoder may calculate total energy of a residual signal for each sub-band as represented by Equation 8, and determine a scale factor by comparing the calculated total energy and the number of bits used for quantization. To compare the total energy and the number of bits used for quantization, the encoder may divide the total energy by a reference decibel (dB/bit) and compare a result of the dividing to the number of bits used for quantization. The reference decibel may be 6 dB/bit, for example.

$$energy = \frac{1}{\begin{matrix}Ab ( k + 1 ) - \\ Ab ( k ) + 1\end{matrix}} {\sum }_{k = Ab ( k )}^{k = Ab ( k + 1 )} {\vert res ( k ) \vert}^{2} 0 \leq k \leq K - 1 \qquad [ Equation 8 ]$$

In Equation 8, energy denotes total energy of a residual signal in a sub-band. K denotes the number of sub-bands, and k denotes one of the sub-bands. Ab( ) denotes an index corresponding to a boundary between the sub-bands, and Ab(0) may be 0. The encoder may calculate the total energy by calculating a sum of absolute values of a residual signal (res(k)) corresponding to a kth sub-band. For example, the encoder may calculate the total energy by diving the sum of the absolute values of the residual signal (res(k)) corresponding to the kth sub-band by a range of the kth sub-band.

When a result of dividing the total energy by the reference decibel is greater than the number of bits used for quantization, the encoder may divide the total energy by a factor of two of the reference decibel and compare a result of the dividing to the number of bits used for quantization.

Here, when the result of dividing the total energy by a factor of two of the reference decibel is less than the number of bits used for quantization, the encoder may determine, to be the scale factor, a candidate decibel that allows a result of dividing the total energy by the candidate decibel to be less than the number of bits used for quantization and allows a difference from the number of bits used for quantization to be minimal, among candidate decibels that are greater than the reference decibel and less than a value two times greater than the reference decibel.

In contrast, when the result of dividing the total energy by a factor of two of the reference decibel is greater than the number of bits used for quantization, the encoder may divide the total energy by a factor of four of the reference decibel and perform the process described above.

In addition, when the result of dividing the total energy by the reference decibel is less than the number of bits used for quantization, the encoder may divide the total energy by a factor of ½ of the reference decibel and compare a result of the dividing to the number of bits used for quantization.

Here, when the result of dividing the total energy by a factor of ½ of the reference decibel is less than the number of bits used for quantization, the encoder may determine, to be the scale factor, a candidate decibel that allows a result of dividing the total energy by the candidate decibel to be less than the number of bits used for quantization and allows a difference from the number of bits used for quantization to be minimal, among candidate decibels that are less than the reference decibel and greater than a value ½ times the reference decibel.

In contrast, when the result of dividing the total energy by a factor of ½ of the reference decibel is greater than the number of bits used for quantization, the encoder may divide the total energy by a factor of ¼ of the reference decibel and perform the process described above.

For detailed example, when the reference decibel is 6 dB and the number of bits used for quantization is greater than a result of dividing the total energy by the reference decibel, the encoder may compare a result of dividing the total energy by 3 dB and the number of bits used for quantization. In this example, the encoder may determine, to be the scale factor, a candidate decibel that allows a difference between a result of dividing the total energy by the candidate decibel and the number of bits used for quantization to be minimal, from among candidate decibels that are greater than 3 dB and less than 6 dB. The encoder may divide the total energy by 0.125 dB at the least, and compare a result of the dividing and the number of bits used for quantization.

For another detailed example, when the number of bits used for quantization is N, a decibel that may be represented with bits used for quantization may be approximately 6*N dB. The encoder may compare 6*N dB and total energy for each sub-band, and determine a scale factor that allows the total energy to be represented with 6*N dB. When N=2 bit and total energy of a sub-band is 20 dB, it may not be represented with 12 dB which is N*6 dB. Thus, the encoder may determine a scale factor that lowers the total energy of the sub-band up to 12 dB in a binary manner.

That is, the encoder may determine, to be a scale factor for each sub-band, a candidate decibel that allows, to be minimal, a difference between a result of dividing total energy for each sub-band by the candidate decibel and the number of bits used for quantization for each sub-band.

In operation 403, the encoder may quantize the residual signal using the determined scale factor. For example, the encoder may obtain a quantized residual signal based on Equations 9 through 11 b below.

abs(resQ(B(k):B(k+1)))=10 log 10(abs(res_{f}[B(k):B(k+1)])²)−SF(k), 0≤k≤B−1 [Equation 9]

angle(resQ(B(k):B(k+1)))=angle(res_{f}[B(k):B(k+1)]), 0≤k≤B−1 [Equation 10]

resQ(B(k):B(k+1))=abs(resQ(B(k):B(k+1)))exp(j×angle(resQ(B(k):B(k+1)))) [Equation 11]

In Equation 9 above, SF(k) denotes a scale factor determined for a kth sub-band. B(k):B(k+1) denotes an interval corresponding to the kth sub-band. resQ denotes a quantized residual signal, and res_{f} denotes a residual signal. Other variables and functions are the same as described above with reference to Equations 1 through 8.

As represented by Equation 9, the encoder may obtain an absolute value of the quantized residual signal for each sub-band by converting the residual signal into decibels for each sub-band and subtracting the scale factor.

As represented by Equation 10, the encoder may calculate a phase angle of the quantized residual signal (resQ(B(k):B(k+1))) based on a phase angle of the residual signal (res_{f}(B(k):B(k+1))) corresponding to the kth sub-band.

As represented by Equation 11, the encoder may obtain the quantized residual signal from the phase angle and the absolute value of the quantized residual signal. The encoder may determine the residual signal by multiplying an output value of an exponential function (exp( )) associated with the phase angle (angle(resQ(B(k):B(k+1)))) of the quantized residual signal and the absolute value (abs(resQ(B(k):B(k+1)))) of the quantized residual signal. In addition, the encoder may obtain an integer value of the quantized residual signal using an operation method, for example, truncation or rounding off According to an example embodiment, the encoder may encode a quantized signal and a quantized linear prediction coefficient into a bitstream. A method that is used for the encoding is not limited to the examples described herein.

A decoder may extract a quantized linear prediction coefficient and a quantized residual signal from a bitstream received from the encoder. The decoder may then dequantize the quantized linear prediction coefficient and the quantized residual signal. The dequantization may be construed as a process of inversely performing quantization.

For example, the decoder may dequantize the quantized residual signal based on Equations 12 through 14 below.

abs( [symbol] (B(k):B(k+1)))=10 log 10(abs(resQ[B(k):B(k+1)])²+SF(k), 0≤k≤B−1 [Equation 12]

angle( [symbol] (B(k):B(k+1)))=angle(resQ[B(k):B(k+1)]), 0≤k≤B−1 [Equation 13]

[symbol]

(B(k):B(k+1))=abs( [symbol] (B(k):B(k+1)))exp(j×angle( [symbol] (B(k):B(k+1)))) [Equation 14]))

In Equation 12 above, denotes a dequantized residual signal. Other variables and functions may be the same as described above with reference to Equations 1 through 11. That is, the decoder may calculate an absolute value of the dequantized residual signal by adding a scale factor to a result of converting the quantized residual signal for each sub-band.

As represented by Equation 13, the decoder may obtain a phase angle of the dequantized residual signal using a phase angle of the quantized residual signal for each sub-band. As represented by Equation 14, the decoder may obtain the dequantized residual signal from the absolute value and the phase angle of the dequantized residual signal.

The decoder may generate an envelope using the dequantized linear prediction coefficient. The generating of the envelope may be the same as performed in the encoder. In detail, the decoder may convert the dequantized linear prediction coefficient into a frequency domain.

For example, the decoder may convert the linear prediction coefficient into the frequency domain using a DFT. However, a method of converting into the frequency domain is not limited to the foregoing example, and other methods may also be used.

The converted linear prediction coefficient may be indicated as a complex number. The decoder may obtain an absolute value of the converted linear prediction coefficient. The decoder may then group absolute values of the linear prediction coefficient by each sub-band. The decoder may generate an envelope corresponding to a block of an audio signal to be reconstructed by calculating energy of the absolute values of the linear prediction coefficient that are grouped for each sub-band using Equation 1.

The decoder may generate a block of a frequency-domain audio signal using the envelope and the dequantized residual signal. For example, the decoder may generate the frequency-domain audio signal using Equations 15 through 17 below.

abs( [symbol] (A(k):A(k+1)))=10 log 10(abs( [symbol] [A(k):A(k+1)])²+env(k), 0≤k≤K−1 [Equation 15]

angle( [symbol] (A(k):A(k+1)))=angle( [symbol] [A(k):A(k+1)]), 0≤k≤K−1 [Equation 16]

[symbol]

(A(k):A(k+1))=abs( [symbol] (A(k):A(k+1)))exp(j×angle( [symbol] (A(k):A(k+1)))) [Equation 17]))

In Equation 15, env(k) denotes a value corresponding to a kth sub-band in an envelope. [symbol] denotes a frequency-domain audio signal corresponding to the kth sub-band. In Equation 15, K denotes the number of sub-bands, and A(k):A(k+1) denotes an interval corresponding to the kth sub-band. Other variables and functions may be the same as described above with reference to Equations 1 through 14.

That is, the decoder may obtain an absolute value of the audio signal by adding a value of the envelope to a result of converting an absolute value of a dequantized residual signal corresponding to the kth sub-band. As represented by Equation 16, the decoder may calculate a phase angle of the audio signal based on a phase angle of the dequantized residual signal.

In addition, as represented by Equation 17, the decoder may obtain the audio signal from the absolute value and the phase angle of the audio signal. The decoder may obtain the audio signal for each sub-band by multiplying an output value of an exponential function (exp( )) associated with the phase angle (angle( [symbol] (A(k):A(k+1)))) of the audio signal and the absolute value (abs( [symbol] (k):A(k+1)))) of the quantized residual signal.

The decoder may then decode the audio signal by converting the frequency-domain audio signal into a time-domain audio signal. Here, the decoder may use an inverse MDCT (IMDCT) or an inverse DFT (i-DFT), for example.

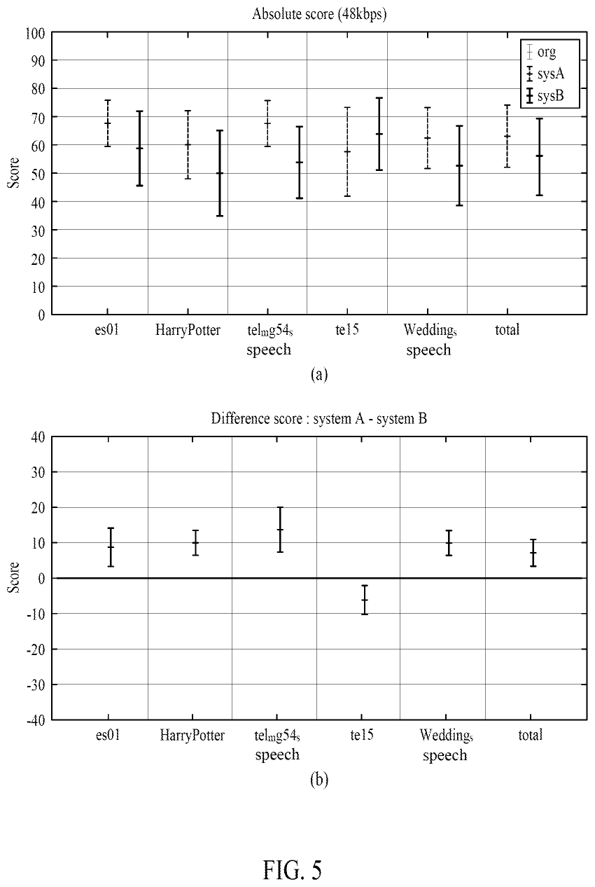

FIG. 5 is a diagram illustrating examples of a graph of experimental results according to an example embodiment.

FIG. 5(a) is a graph that illustrates results of comparing a method described herein and a related existing method in terms of the sound quality of a decoded audio signal that is indicated as an absolute score. In the graph of FIG. 5(a), “sysA” indicates a result obtained from the method described herein, and “sysB” indicates a result obtained from the related existing method. FIG. 5(a) illustrates the results of experiments performed using different items, for example, es01, HarryPotter, and the like.

FIG. 5(b) is a graph that illustrates results of comparing a method described herein and a related existing method in terms of the sound quality of a decoded audio signal that is indicated as a difference score indicating a difference between the method and the related existing method. FIG. 5(b) illustrates the results of experiments performed using different items, for example, es01, HarryPotter, and the like. A low score for tel15 may be due to a difference in noise processing method, not due to the method described herein.

The methods according to the above-described example embodiments may be recorded in non-transitory computer-readable media including program instructions to implement various operations of the example embodiments. The media may also be implemented as various recording media such, as, for example, a magnetic storage medium, an optical read medium, a digital storage medium, and the like.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors. The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums. The non-transitory computer-readable recording medium may include any data storage device that can store data which can be thereafter read by a computer system or processing device.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter.

The above-described devices may be configured to act as one or more software modules in order to perform the operations of the above-described example embodiments, or vice versa.

Although the specification includes the details of a plurality of specific implementations, it should not be understood that they are restricted with respect to the scope of any claimable matter. On the contrary, they should be understood as the description about features that may be specific to the specific example embodiment of a specific subject matter. Specific features that are described in this specification in the context of respective example embodiments may be implemented by being combined in a single example embodiment. On the other hand, the various features described in the context of the single example embodiment may also be implemented in a plurality of example embodiments, individually or in any suitable sub-combination. Furthermore, the features operate in a specific combination and may be described as being claimed. However, one or more features from the claimed combination may be excluded from the combination in some cases. The claimed combination may be changed to sub-combinations or the modifications of sub-combinations.

Likewise, the operations in the drawings are described in a specific order. However, it should not be understood that such operations need to be performed in the specific order or sequential order illustrated to obtain desirable results or that all illustrated operations need to be performed. In specific cases, multitasking and parallel processing may be advantageous. Moreover, the separation of the various device components of the above-described example embodiments should not be understood as requiring such the separation in all example embodiments, and it should be understood that the described program components and devices may generally be integrated together into a single software product or may be packaged into multiple software products.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Therefore, the scope of the disclosure is defined not by the detailed description, but by the claims and their equivalents, and all variations within the scope of the claims and their equivalents are to be construed as being included in the disclosure.

### DESCRIPTION OF REFERENCE NUMERALS

101: Encoder
102: Decoder

1. A method of encoding an audio signal to be performed by an encoder, the method comprising:
identifying a time-domain audio signal block-wise;
quantizing a linear prediction coefficient obtained from a block of the audio signal through linear predictive coding (LPC) generating an envelope based on the quantized linear prediction coefficient;
extracting a residual signal based on the envelope and a result of converting the block into a frequency domain;
grouping the residual signal by each sub-band, and determining a scale factor for quantizing the grouped residual signal;
quantizing the residual signal using the scale factor; and
converting the quantized residual signal and the quantized linear prediction coefficient into a bitstream, and transmitting the bitstream to a decoder.

2. The method of claim 1, wherein the linear prediction coefficient is generated by performing the LPC on a current block that is used for the LPC among identified blocks, based on information associated with a previous block of the current block and information associated with a subsequent block of the current block.

3. The method of claim 1, wherein the generating of the envelope comprises:
converting the quantized linear prediction coefficient into the frequency domain;
grouping the converted linear prediction coefficient by each sub-band; and
generating the envelope corresponding to the block by calculating energy of the grouped linear prediction coefficient.

4. The method of claim 1, wherein the determining of the scale factor comprises:
determining the scale factor by a median value of the envelope, or determining the scale factor based on the number of bits available for quantizing the residual signal.

5. The method of claim 4, wherein the number of bits available for the quantizing is determined for each sub-band,
wherein a greater number of bits is allocated when the sub-band is a lower band, and a smaller number of bits is allocated when the sub-band is a higher band.

6. A method of decoding an audio signal to be performed by a decoder, the method comprising:
extracting a quantized linear prediction coefficient and a quantized residual signal from a bitstream received from an encoder;
dequantizing the quantized linear prediction coefficient and the quantized residual signal;
generating an envelope from the dequantized linear prediction coefficient;
extracting a frequency-domain audio signal using the dequantized residual signal and the envelope; and
decoding the audio signal by converting the extracted audio signal into a time domain.

7. The method of claim 6, wherein the dequantizing of the quantized residual signal comprises:
dequantizing the residual signal using a scale factor determined for each sub-band.

8. The method of claim 7, wherein the scale factor is determined by a median value of the envelope or determined based on the number of bits available for quantizing the residual signal.

9. The method of claim 6, wherein the generating of the envelope comprises:
converting the dequantized linear prediction coefficient into a frequency domain;
grouping the converted linear prediction coefficient by each sub-band; and
generating the envelope by calculating energy of the grouped linear prediction coefficient.

10. An encoder configured to perform a method of encoding an audio signal, the encoder comprising:
a processor,
wherein the processor is configured to identify a time-domain audio signal block-wise, quantize a linear prediction coefficient obtained from a block through linear predictive coding (LPC), generate an envelope based on the quantized linear prediction coefficient, extract a residual signal based on the envelope and a result of converting a block of the audio signal into a frequency domain, group the residual signal by each sub-band, determine a scale factor for quantizing the grouped residual signal, quantize the residual signal using the scale factor, and convert the quantized residual signal and the quantized linear prediction coefficient into a bitstream and transmit the bitstream to a decoder.

11. The encoder of claim 10, wherein the linear prediction coefficient is generated by performing the LPC on a current block that is used for the LPC among identified blocks, based on information associated with a previous block of the current block and information associated with a subsequent block of the current block.

12. The encoder of claim 10, wherein the processor is configured to:
convert the quantized linear prediction coefficient into the frequency domain, group the converted linear prediction coefficient by each sub-band, and generate the envelope corresponding to the block by calculating energy of the grouped linear prediction coefficient.

13. The encoder of claim 10, wherein the processor is configured to:
determine the scale factor by a median value of the envelope or determine the scale factor based on the number of bits available for quantizing the residual signal.

14. The encoder of claim 13, wherein the number of bits available for the quantizing is determined for each sub-band,
wherein a greater number of bits is allocated when the sub-band is a lower band, and a smaller number of bits is allocated when the sub-band is a higher band.
